(19) United States
(12) Patent Application Publication
(10) Pub. No.: US 2025/0007348 A1
(43) Pub. Date: Jan. 2, 2025

(54) Grounding Brush Assembly

(71) Applicant: AKTIEBOLAGET SKF, GOTEBORG (SE)

(72) Inventors: Anthony SIMONIN, Tours (FR); Thomas PERROTIN, Saint Roch (FR); Emmanuel BENEVISE, Monts (FR); Pierre MAGNIER, Luynes (FR)

(21) Appl. No.: 18/745,073

(22) Filed: Jun. 17, 2024

(30) Foreign Application Priority Data
Jun. 30, 2023 (FR) 2306929

(51) Int. Cl. H02K 5/14; H01R 39/39; H01R 43/06; H02K 11/40

(52) U.S. Cl. CPC H02K 5/145; H01R 39/39; H01R 43/06; H02K 11/40; H01R 2201/10

(57) ABSTRACT

A method is for assembling an assembly including a brush having a support with a mounting portion and a mounting plate having a main body and tabs, each tab having an axial portion in radial contact with the support. The method includes the steps of: positioning the support against the main body, the mounting portion having, in a free state, an outside diameter; forming the tabs by partially cutting the mounting plate; and assembling the tabs against the mounting portion, the mounting portion having, in the area of the axial portion of each tab, an outside diameter that is lesser than its outside diameter in the free state.

### CROSS-REFERENCE

This application claims priority to French patent application no. 2306929 filed on Jun. 30, 2023, the contents of which are fully incorporated herein by reference.

### BACKGROUND OF THE INVENTION

The present invention relates to the field of grounding devices for controlling the shaft voltage generated in electric motors or machines, and in particular grounding brush assemblies.

In an electric motor or machine, at least one rolling element bearing is typically mounted between the casing of the electric motor or machine and a rotary shaft in order to rotatably support the shaft.

During machine operation as the shaft rotates, a difference in electrical potential between the shaft and the casing of the electric motor/machine may arise, such potential difference generating an electric current between the inner ring of the rolling bearing, which is rigidly secured to the shaft, and the bearing outer ring, which is rigidly secured to the casing.

Electrical current passing through the rolling bearing can damage the components of the bearing, in particular the rolling elements and the raceways formed on the inner and outer rings. Electrical discharges can also generate vibration.

To overcome these drawbacks, it is a known practice to ground or earth the rotary shaft using a grounding brush comprising conductive fibers. The grounding brush is usually mounted in the bore of the casing of the electric motor such that the free ends of the fibers are in radial contact with the outer surface of the rotary shaft.

Due to the conductivity of the fibers, the brush is maintained at the same electrical potential as the casing of the electric motor. The inner and outer rings of the rolling bearing are also at the same electrical potential, which reduces or even eliminates problematic electrical discharges through the rolling bearing.

US Patent Publication No. 2021/0021180 A1 discloses a grounding brush assembly comprising a grounding brush including a support and a plurality of conductive fibers mounted in the support, and an annular mounting plate including a plurality of tabs for radial and axial retention of the support of the grounding brush and an annular outer flange radially surrounding the brush and the tabs. The tabs are preferably formed by plastic deformation of the mounting plate.

### SUMMARY OF THE INVENTION

The present invention aims to provide an alternative attachment for attaching a grounding brush to a mounting plate.

The present invention relates to a method for assembling a grounding brush assembly comprising a grounding brush and a brush mounting plate, the brush being provided with a plurality of conductive fibers and with a support inside which the conductive fibers are housed.

The support comprises a mounting portion, a first lateral rim extending the mounting portion on one side, and a second lateral rim extending the mounting portion on the other side, the first and second lateral rims axially gripping the conductive fibers.

The mounting plate is provided with a main body and a plurality of retention tabs for retaining the support of the brush, each retention tab being provided with an axial portion extending axially from the main body, radially locally surrounding the support of the brush and being in radial contact with the support, and a radially inwardly bent portion which is located at the free end of the axial portion.

According to a general feature, the method comprises the following steps:
a positioning step in which the support of the brush is brought axially into axial contact against the main body of the mounting plate, the mounting portion of the support having, in the free state, an outside diameter;
a step of forming the retention tabs of the mounting plate by partially cutting the mounting plate and by bending; and
an assembly step in which the retention tabs of the mounting plate are brought into radial contact against the mounting portion of the support of the brush, the mounting portion of the support having, in the assembled state and in the area of the axial portion of each retention tab, an outside diameter that is strictly smaller than its outside diameter in the free state.

Thus, the brush and the mounting plate are rigidly secured together, axially and radially, simply and inexpensively by virtue of the retention tabs for retaining the support of the brush. The brush and the mounting plate are also rigidly secured together circumferentially, simply and inexpensively by virtue of the retention tabs for retaining the support of the brush which locally deform the mounting portion to an outside diameter which is smaller than its initial diameter in the free state.

The retention tabs may be brought into contact with the mounting portion of the support of the brush such that there is an axial clearance between the bent portion of each of the tabs and the second lateral rim of the support.

The retention tabs may be brought into contact with the mounting portion of the support of the brush such that the outside diameters of the mounting portion of the support are identical.

The present invention also relates to a grounding brush assembly comprising a grounding brush and a brush mounting plate, the brush being provided with a plurality of conductive fibers and with a support inside which the conductive fibers are housed.

The support comprises a mounting portion, a first lateral rim extending the mounting portion on one side, and a second lateral rim extending the mounting portion on the other side, the first and second lateral rims axially gripping the conductive fibers.

The mounting plate is provided with a main body and a plurality of retention tabs for retaining the support of the brush, each retention tab being provided with an axial portion extending axially from the main body, radially locally surrounding the support of the brush and being in radial contact with the support, and a radially inwardly bent portion which is located at the free end of the axial portion.

Such an assembly may be obtained by implementing a method as defined above.

According to a general feature, the mounting portion of the support is corrugated in the circumferential direction, the mounting portion of the support comprising alternating segments of small outside diameter and segments of large outside diameter, the axial portion of each retention tab being in radial contact with a segment of small outside diameter of the mounting portion.

There may be an axial clearance between the bent portion of each tab and the second lateral rim of the support.

The mounting plate may comprise at least one centering portion extending the main body of the mounting plate at least axially, which is offset radially outwards with respect to the support and has an outer surface defining the outside diameter of the mounting plate.

The present invention also relates to an electric motor comprising a casing, a shaft and a grounding brush assembly as defined above and mounted radially between the casing and the shaft, the conductive fibers of the assembly being in contact with the shaft, the mounting plate being in radial contact with the bore of the casing.

### BRIEF DESCRIPTION OF THE SEVERAL VIEWS OF THE DRAWINGS

The present invention will be understood more clearly on reading the detailed description of embodiments, provided by way of non-limiting examples and illustrated by the attached drawings in which:

FIG. 1 is a view in axial cross section of a grounding brush assembly mounted radially between a rotary shaft and a casing of an electric motor according to an exemplary embodiment of the invention;

FIG. 2 is an end-on view of the grounding brush assembly of FIG. 1;

FIG. 3 is a view in cross section of the assembly of FIG. 2 along the axis III-III;

FIG. 4 schematically depicts a method for assembling a grounding brush assembly according to the invention;

FIG. 5 schematically depicts a positioning step of the method of FIG. 4;

FIG. 6 schematically depicts a forming step of the method of FIG. 4; and

FIG. 7 schematically depicts an assembly step of the method of FIG. 4.

### DETAILED DESCRIPTION OF THE INVENTION

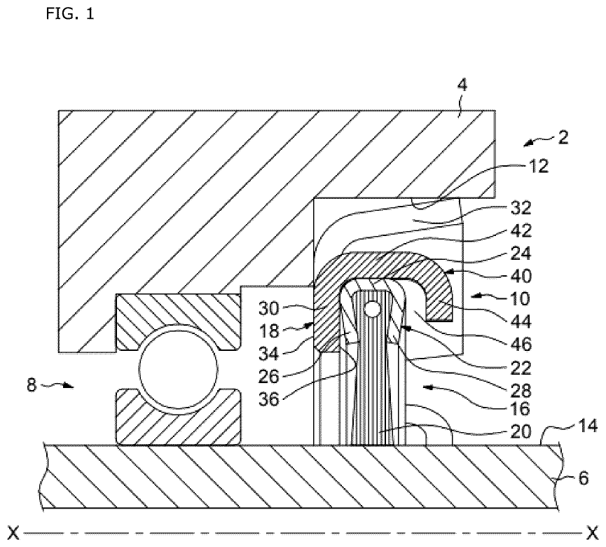

FIG. 1 shows, in axial cross section, part of an electric motor or machine 2 comprising a fixed casing 4, a shaft 6 rotatable about a central axis X-X, and a bearing 8 rotatably supporting the shaft 6. The bearing 8 may be a rolling bearing such as a ball bearing as depicted, but may alternatively have any other types of rolling elements, for example cylindrical rollers, tapered rollers, etc. and may even be formed as a plain bearing.

The motor 2 further comprises a grounding brush assembly 10 mounted radially between the bore of the casing 12 and the cylindrical outer surface 14 of the shaft 6. The assembly 10 is, for example, force-fitted in the bore of the casing 12.

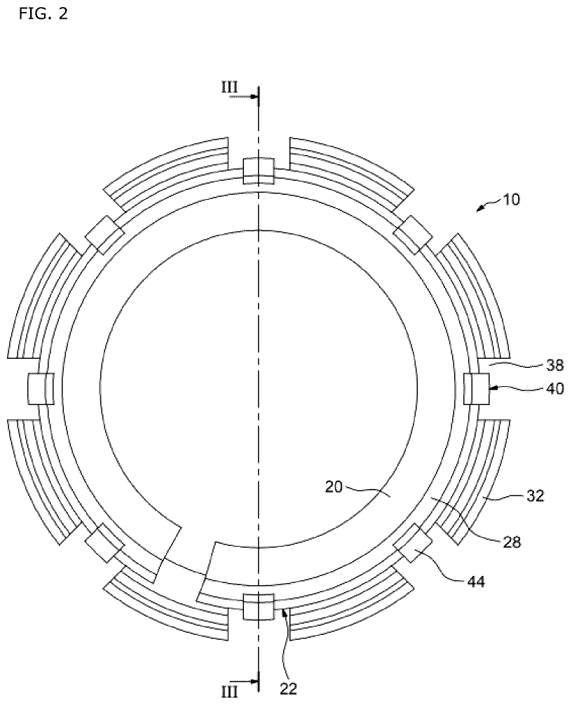

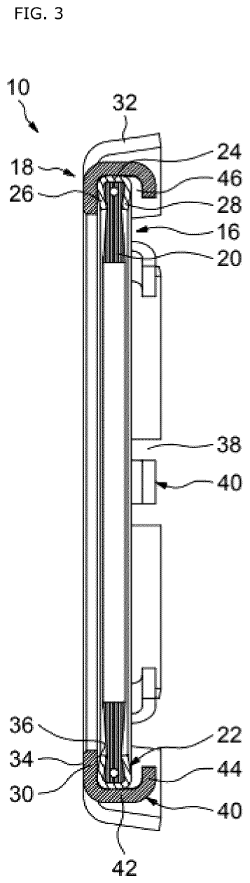

As shown more clearly in FIGS. 2 and 3, the grounding brush assembly 10 has a generally annular shape and basically comprises a grounding brush 16 and a brush mounting plate 18. The brush 16 includes a support 22 and a plurality of conductive fibers 20 disposed at least partially within the support 22. The conductive fibers 20 are formed of an electrically conductive material, such as for example, carbon, stainless steel, a conductive plastic such as acrylic or nylon fibers or any other appropriate material. The plurality of conductive fibers 20 preferably take the form of an open ring. In the example shown, the conductive fibers 20 are bent around a connecting wire (not indicated). The free distal end of each of the conductive fibers 20 is in radial contact with the cylindrical outer surface 14 of the shaft 6.

To ensure the mounting and retention of the conductive fibers 20, the support 22 of the brush 16 includes a mounting portion 24, a first lateral rim 26 extending from one axial side of the mounting portion 24 and a second lateral rim 28 extending from another axial side of the mounting portion 24.

The mounting portion 24 extends from a large-diameter edge of the first lateral rim 26 and the first lateral rim 26 extends radially inwardly from the mounting portion 24. Similarly, the mounting portion 24 extends from a large-diameter edge of the second lateral rim 28 and the second lateral rim 28 extends radially inwardly from the mounting portion 24. The second lateral rim 28 extends from the mounting portion 24 on an axial side opposite to the first lateral rim 26.

The mounting portion 24 preferably extends substantially axially, but may alternatively extend obliquely. The mounting portion 24 and the first and second lateral rims 26, 28 are of generally annular shape and delimit a channel that is open radially inwardly, inside which an outer radial end of each of the conductive fibers 20 is located. The first and second lateral rims 26, 28 axially grip the conductive fibers 20 and the conductive fibers 20 bear axially on either side against the first and second lateral rims 26, 28.

In the depicted exemplary embodiment, the conductive fibers 20 bear radially against the mounting portion 24 and the first and second lateral rims 26, 28 extending obliquely inwardly from the mounting portion 24. In a variant, the first and second lateral rims 26, 28 may extend substantially radially.

The mounting plate 18 includes an annular main body 30 bearing axially against the first lateral rim 26 of the support 22 of the brush 16 and a plurality of centering portions 32 extending obliquely outwardly from a large-diameter edge of the main body 30.

The main body 30 of the mounting plate 18 has two opposite end faces 34, 36 which delimit an axial thickness of the main body 30. The first lateral rim 26 of the support 22 of the brush 16 bears axially against the end face 36 of the main body 30.

The centering portions 32 of the mounting plate 18 are spaced apart from one another in the circumferential direction of the grounding brush assembly 10, and a plurality of notches 38 are each defined circumferentially between each two consecutive centering portions 32.

The centering portions 32 define an outside diameter of the mounting plate 18. Specifically, the outer surfaces of the centering portions 32 collectively define the outside diameter of the mounting plate 18. The centering portions 32 enable centering of the mounting plate 18 after mounting of the grounding brush assembly 10 within the bore 12 of the casing 4 of the associated electric motor 2.

Each centering portion 32 in this case extends obliquely outwardly, at least locally surrounding and being radially spaced from the mounting portion 24 of the brush support 22. In a variant, each centering portion 32 may extend entirely axially. In another variant, each centering portion 32 may extend from the plate 18 in a direction axially away from the support 22 of the brush 16.

The mounting plate 18 further includes a plurality of retention tabs 40 for axially rigidly securing the support 22 of the brush 16 relative to the mounting plate 18.

Each retention tab 40 is includes an axial portion 42 extending axially from the main body 30 of the mounting plate 18 so as to locally radially surround and be in radial contact with the support 22 of the brush 16. More specifically, each tab 40 is in radial contact with the mounting portion 24 of the support 22 such that the tabs 40 of the mounting plate 18 interact by radial contact with the support 22 of the brush 16 to axially retain the support 22 of the brush 16 with respect to the mounting plate 18.

The axial portion 42 of each tab 40 is spaced radially inwardly from the centering portions 32 of the mounting plate 18.

Each retention tab 40 is also provided with a radially inwardly bent portion 44 which is located at a free end of the axial portion 42 of the tab 40.

The bent portion 44 of each tab 40 is axially spaced from the second lateral rim 28 of the support 22 of the brush 16 such that there is an axial clearance 46 between the bent portion 44 and the second lateral rim 28 of the support 22.

The retention tabs 40 are offset from one another in the circumferential direction of the assembly 10, in this case regularly or evenly. In the exemplary embodiment illustrated, the mounting plate 18 has eight tabs 40, but may alternatively have more or fewer than eight tabs 40.

The mounting portion 24 of the support 22 of the brush 16 is “corrugated” in the circumferential direction of the assembly 10 after being engaged by the retainer tabs 40 when the support 22 is assembled to the mounting plate 18. Specifically, in a “free state” before assembly to the mounting plate 18, the mounting portion 24 of the support 22 has an outside diameter D1 with a constant value about the entire circumferential perimeter of the portion 24. After assembly to the mounting plate 18, the mounting portion 24 of the support 22 has segments engaged by one of the retention tabs 40 with a second diameter D2 alternating between segments having the first outside diameter D1, the second diameter having a value less than the first diameter. The segments of the mounting portion 24 having the second diameter D2 are each formed by local radially inward deflection of the support 22 caused by the engagement of one of the retention tabs 40.

Thus, after assembly of the support 22 and the mounting plate 18, the axial portion 42 of each tab 40 of the mounting plate 18 is in radial contact with one segment of the mounting portion 24 of the support 22 having the outside diameter D2 (i.e., with a lesser value than D1).

In the exemplary embodiment illustrated, the mounting plate 18 includes tabs 40 and centering portions 32 alternating in the circumferential direction of the assembly 10. Each tab 40 is circumferentially spaced from two centering portions 32 that are directly adjacent thereto. Alternatively, the mounting plate 18 could have a different number of tabs 40 and of centering portions 32. In a variant, the tabs 40 could be in contact with, in the circumferential direction of the assembly 10, one or both centering portions 32 that are directly adjacent thereto.

The mounting plate 18 and the support 22 of the brush 16 are two separate parts.

The mounting plate 18 and the grounding brush 16 comprise an electrically conductive material, for example aluminum, stainless steel, bronze, copper or another material.

In the example shown, the mounting plate 18 includes a plurality of centering portions 32 spaced apart regularly or evenly in the circumferential direction of the assembly 10. In a variant, the mounting plate 18 may include a plurality of centering portions 32 spaced apart irregularly or unevenly in the circumferential direction of the assembly 10.

In another variant, the mounting plate 18 may include only a single annular centering portion 32 forming a flange.

In the example shown, the mounting plate 18 comprises a plurality of tabs 40 spaced apart regularly in the circumferential direction of the assembly 10. In a variant, the mounting plate 18 may comprise a plurality of tabs 40 spaced apart irregularly or unevenly in the circumferential direction of the assembly 10.

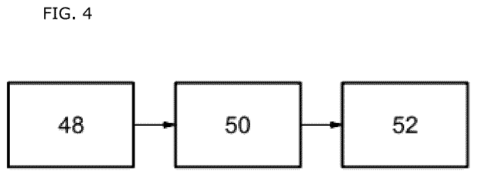

FIG. 4 schematically depicts a method for assembling the assembly 10.

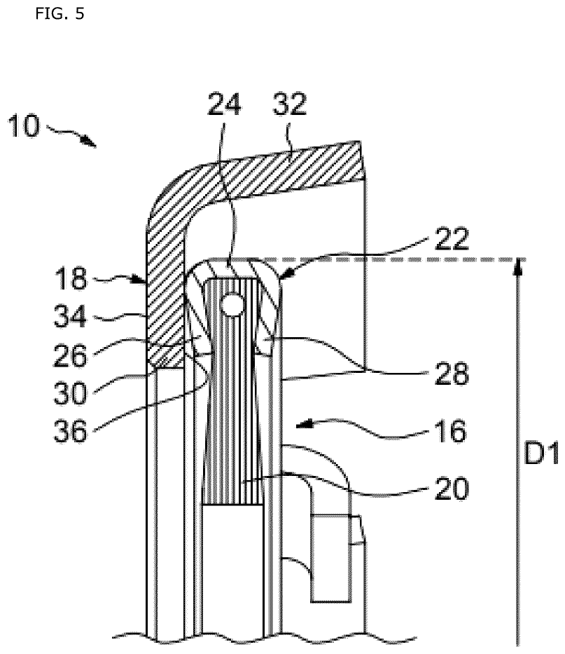

The method starts with a positioning step 48 shown in FIG. 5 in which the support 22 of the brush 16 is brought axially into axial contact against the main body 30 of the mounting plate 18, the first lateral rim 26 of the support bearing axially against the main body 30 of the mounting plate 18. In the free state, the mounting portion 24 of the support 22 has an outside diameter D1 that is substantially constant (i.e., has a constant value) about the entire perimeter of the mounting portion 24.

The support 22 of the brush 16 is not yet rigidly secured to the mounting plate 18 in the positioning step 48.

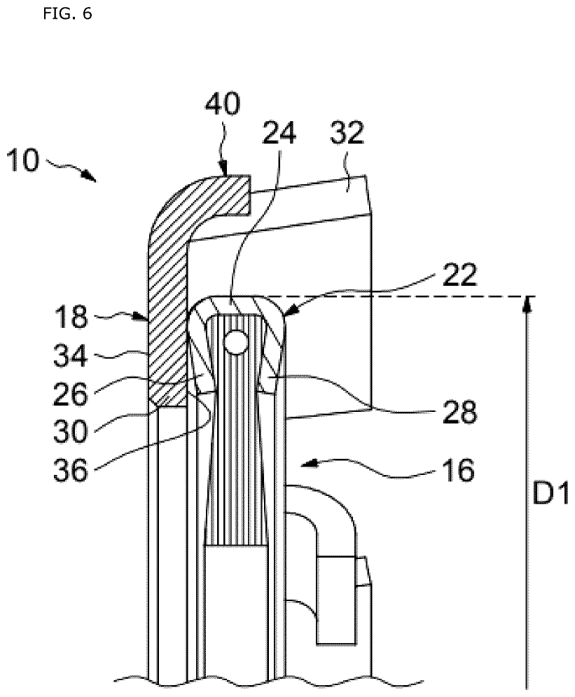

Next is a step 50 of forming the tabs 40 in which the mounting plate 18 is cut and bent so as to form the tabs 40. This step is shown in FIG. 6. In a variant, the forming step 50 may be performed before the positioning step 48.

The centering portions 32 and the notches 38 are also formed during the step 50.

Then, an assembly step 52 is performed during which the tabs 40 of the mounting plate 18 are brought into radial contact against the mounting portion 24 of the support 22 of the brush 16 in such a way as to locally deform, or radially inwardly deflect, the support 22 of the brush 16.

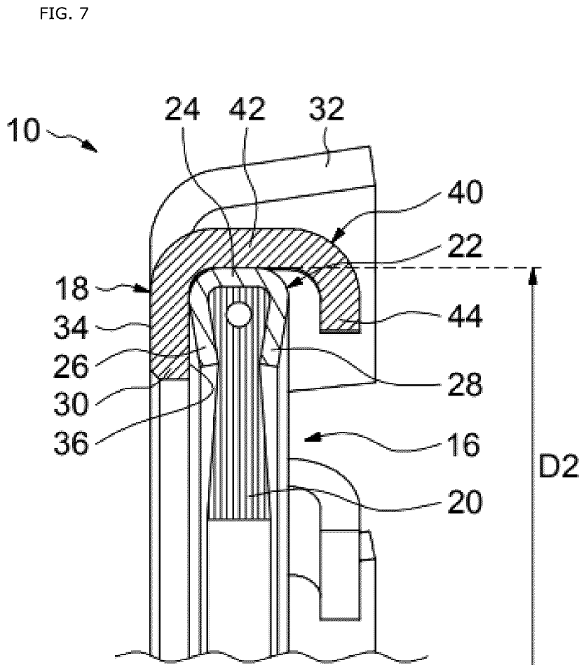

During this step shown in FIG. 7, the tabs 40 of the mounting plate 18 are brought into radial contact against the mounting portion 24 of the support 22 such that the mounting portion 24 has locally, in the area where each tab 40 bears, an outside diameter D2 that is less than the outside diameter D1 (i.e., D1 has a value greater than the value of D2). Thus, the segments of the mounting portion 24 having the smaller or lesser second diameter D2 are formed. As such, after assembly, the mounting portion 24 of the support 22 has a corrugated shape in the circumferential direction, with alternating segments or areas of small outside diameter D2 in the areas with tabs 40, and segments or areas in which of large outside diameter D1 in the areas without tabs 40.

Preferably, the segments of the mounting portion 24 of the support 22 with the small outside diameter D2 are formed in such a way as to leave the axial clearance 46 between the radially inwardly bent portion 44 of the tabs 40 of the mounting plate 18 and the second lateral rim 28 of the support 22.

In the example shown, the tabs 40 of the mounting plate 18 are brought into radial contact against the mounting portion 24 of the support 22 such that the outside diameters D2 thereof are identical (i.e., have substantially the same value). Alternatively, the segments of the mounting portion 24 having the second diameter D2 may be formed such that the values of the second diameter D2 are different in different segments, but are each smaller or lesser than the outside diameter D1 of the mounting portion 24 of the support 22 in the free state.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A method for assembling a grounding brush assembly, the grounding brush assembly including a grounding brush and a brush mounting plate, the brush including a support and a plurality of conductive fibers disposed at least partially within the support, the support including a mounting portion, a first lateral rim extending from one axial side of the mounting portion, and a second lateral rim extending from another axial side of the mounting portion, the first and second lateral rims axially gripping the conductive fibers, the mounting plate including a main body and a plurality of retention tabs for retaining the support of the brush, each retention tab having an axial portion extending axially from the main body, locally radially surrounding and being in radial contact with the support of the brush, and a radially inwardly bent portion located at a free end of the axial portion, the method comprising the steps of:
positioning the support of the brush axially into axial contact against the main body of the mounting plate, the mounting portion of the support having, in a free state, an outside diameter;
forming each one of the plurality of retention tabs of the mounting plate by partially cutting the mounting plate and by bending a portion of the mounting plate; and
assembling the brush and the mounting plate by placing the retention tabs of the mounting plate into radial contact against the mounting portion of the support of the brush, the outside diameter of the mounting portion of the support having, in an assembled state and in the area of the axial portion of each retention tab, an outside diameter less than the outside diameter in the free state.

2. The method according to claim 1, wherein the plurality of retention tabs are placed into contact with the mounting portion of the support of the brush such that an axial clearance is defined between the bent portion of each one of the retention tabs and the second lateral rim of the support.

3. The method according to claim 1, wherein the retention tabs engaged with the mounting portion of the support of the brush such that the outside diameter of each segment of the mounting portion in contact with the retention tabs has the same value.

4. A grounding brush assembly comprising:
a grounding brush including a support and a plurality of conductive fibers disposed at least partially within the support, the support having a mounting portion, a first lateral rim extending from one axial side of the mounting portion, and a second lateral rim extending from another axial side of the mounting portion, the first and second lateral rims axially gripping the conductive fibers; and
a brush mounting plate including a main body and a plurality of retention tabs for retaining the support of the brush, each retention tab having an axial portion extending axially from the main body, locally radially surrounding and being in contact with the support of the brush, and a radially inwardly bent portion located at a free end of the axial portion;
wherein the mounting portion of the support is corrugated in the circumferential direction and has alternating segments of small outside diameter and segments of large outside diameter, the axial portion of each retention tab being in radial contact with a separate one of the segments of small outside diameter of the mounting portion.

5. The grounding brush assembly according to claim 4, wherein there is an axial clearance between the bent portion of each retention tab and the second lateral rim of the support.

6. The grounding brush assembly according to claim 4, wherein the mounting plate includes at least one centering portion extending at least axially from the main body of the mounting plate, the at least one centering portion being offset radially outwardly with respect to the support of the brush and has an outer surface defining an outside diameter of the mounting plate.

7. An electric motor comprising:
a casing having a bore;
a shaft; and
a grounding brush assembly according to claim 4 mounted radially between the casing and the shaft, the conductive fibers of the grounding brush assembly being in contact with the shaft and the mounting plate being in radial contact with the bore of the casing.
